(19) United States
(12) Patent Application Publication
(10) Pub. No.: US 2018/0317383 A1
(43) Pub. Date: Nov. 8, 2018

(54) MOWING SYSTEM THAT REDUCES EXPOSURE TO DUST AND DEBRIS

(71) Applicant: Glenn M. BRYANT, Cleveland, TX (US)

(72) Inventor: Glenn M. BRYANT, Cleveland, TX (US)

(21) Appl. No.: 15/588,040

(22) Filed: May 5, 2017

(51) Int. Cl. A01D 34/00; A42B 3/28; A42B 3/22

(52) U.S. Cl. CPC A01D 34/001; A42B 3/286; A01D 2101/00; A42B 3/225; A42B 3/283

(57) ABSTRACT

A dust-free mowing system has a mower, a container with an interior volume removably affixed to the mower, a blower affixed to the container, a hose positioned within the interior volume of the container, a water separator connected to the hose and extending outwardly of the container, a conduit connected or interconnected to the hose and extending outwardly of the container, and a hood connected or interconnected to the conduit. The blower is connected or interconnected to the hose so as to pass an air flow through the hose. The water separator is adapted to remove liquids from an interior of the hose. The hood is adapted to fit over a human head.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present invention relates to lawnmowers. More particular, the present invention relates to systems that reduce the amount of dust or debris encountered by the operator of the mower. More particularly, the present invention the relates to systems whereby a hood can be placed over the head of the operator of a mower so as to reduce exposure to dust and debris.

### 2. Description of Related Art Including Information Disclosed Under 37 CFR 1.97 And 37 CFR 1.98

So-called riding lawnmowers and related lawn and farm vehicles are well known to those skilled in the art. A riding lawnmower becomes a practical necessity to a landowner who has substantial acreage and a lawn which must be mowed and maintained. Other lawnmowers are also known in the art such as gas-powered lawnmowers, electric lawnmowers, and push lawnmowers. The mowers offer the operator little in the way of protection from exposure to sun, heat, dust and insects. This can become troublesome to the operator after an extended period of time.

In the case of lawn mowing, a person may sit on a riding lawnmower and traverse the lawn so as to cut the lawn in the desired manner. Throughout these cutting activities, the person riding the lawnmower is subjected to a large amount of dirt, pollen and debris. Typically, the person will inhale a great deal of this dirt, pollen and the debris during the course of mowing the lawn. This is particularly a problem for the persons that are allergy sufferers. As such, a need has developed so as to protect such persons from those encounters with pollen, dirt and debris while, at the same time, providing a cooling effect to the users.

For those workers that operate lawn mowing equipment, the outdoor environment can be particularly hazardous and fatiguing. In particular, a person can become overheated during the course of mowing a lawn. Whenever a person becomes overheated, it is necessary for them to take a break in order to cool down. Whenever such a person takes a break, this can delay the time required to complete the lawn mowing task. This can be economically troublesome when the lawnmower operator is part of a landscaping and lawn maintenance crew. Whenever breaks are needed, this reduces the efficiency of the landscaping operation and can lead to increased costs. As such, a need has developed whereby lawnmower operators can maintain a cool and comfortable environment while carrying out the necessary activities associated with the lawnmower.

In the past, various patents have issued relating to the control of dust and debris for the benefit of the lawnmower operator. For example, an early patent was U.S. Pat. No. 2,627,217, issued on Feb. 3, 1953 to Hainke et al. This patent describes a protective hood for lawnmower operators. The protective hood includes an upright standard, a frame on this standard and extending laterally outwardly from the uppermost end thereof, a frustoconical cover on the frame having an inlet opening formed therein at its uppermost apex end, an air filter closing the opening, and a means of one side of the filter for directing a current of air downwardly through the filter and below the cover. The air filter is dome-shaped and extends upwardly above the cover. The air filter is entirely exposed to a free flow of air therethrough throughout its entire area.

U.S. Pat. No. 2,817,281, issued on Dec. 24, 1957 to Schwan et al., teaches an air-circulating parasol for protection against dust, insects and sun. This parasol includes an enlarged, overhead hood with a means for supporting the hood in a predetermined position. The hood has a substantial cylindrical and diminished upper portion and flares out widely below the upper portion so as to produce an internal rounded shoulder. It then flares outwardly and turns downwardly to form an annular substantially vertical skirt of substantial circumference in contrast to the circumference of the upper portion. The connection between the upper portion and the skirt includes an internal leak convex annular shoulder merging into a slightly upwardly offset annular hood portion disposed above the vertical skirt portion. A rotary fan is mounted axially within the upper portion for circulating air downwardly.

U.S. Pat. No. 2,865,159, issued on Dec. 23, 1958 to O. Musgrave, describes a riding lawnmower which protects the rider of the lawnmower from fumes, dust and cuttings associated with the mowing operation. This riding lawnmower includes a removable hood extending over the engine and a cross-beam forward of and below the seat so as to protect the rider from the engine. The removable hood protects the rider from the heat of the engine, the dust and the cuttings associated with the rotation of the cutting blade. The hood has openings forwardly and rearwardly for the passage of air along the member longitudinally over and under the engine during movement of the mower.

U.S. Pat. No. 4,995,306, issued on Feb. 26, 1991 to R. E. Rush, shows an air circulating system for a person operating an engine-powered piece of agricultural equipment, in particular a lawnmower. This air circulating system includes a fan rotatably carried within a housing and having an air inlet port and an air outlet port. The housing is mounted on to the lawnmower adjacent to the engine so that the engine can rotate the fan. An elongated duct is connected to the outlet port of the housing for directing air driven by the fan toward the person while operating the lawnmower so as to provide a degree of comfort during hot days.

U.S. Pat. No. 5,119,718, issued on Jun. 9, 1992 to Wagner et al., teaches a ventilating arrangement for the cab of a vehicle. This ventilating arrangement draws air from the outside of the cab through the cabin roof. The air flows through at least one generally vertical air duct downwardly in the vicinity of the cab floor and is supplied from there to various outlets in the interior of the cab. A filter housing is connected to the lower region of each generally vertical air duct. Each filter housing encloses an air filter that is accessible from the exterior of the cab.

U.S. Pat. No. 6,202,394, issued on Mar. 20, 2001 to W. C. Russ, discloses a downdraft fan system for riding lawnmower. This downdraft fan system is attachable to the riding lawnmower and includes a rotary fan within a supporting frame that is attachable to a roll-bar component of the lawnmower so as to be positioned in a horizontal plane directly above the operator of the lawnmower. The downdraft fan system provides a constant flow of ambient air downwardly over the operator of the lawnmower to provide protection from heat exposure, dust, and biting insects while operating the lawnmower.

U.S. Pat. No. 6,935,944, issued on Aug. 30, 2005 to F. E. Bigelow, teaches an air system for a vehicle. This air system directs a flow of air at the rear of a head and/or neck of the person occupying the vehicle. It also can direct a flow of air to a space under a roof or canopy of the vehicle so as to dissipate hot air, dust and debris from beneath the roof or canopy.

U.S. Pat. No. 8,720,971, issued on May 13, 2014 to W. Russ, provides a fan and canopy assembly for a riding lawnmower or other vehicle. This canopy assembly includes a canopy, and opening in the canopy, a downdraft fan accommodated within the opening of the canopy, and a roof cap adapted and sized to be attached to the canopy in a position substantially covering the canopy opening. The roof cap is vertically offset from the canopy so as to form at least one side intake port such that lateral airflow to the downdraft fan is substantially unimpeded.

It is an object of the present invention to provide a dust-free mowing system that can provide comfort to the head of the operator of a mower.

It is another object of the present invention to provide a dust-free mowing system that effectively isolates the head of the operator of the mower from dust, dirt, pollen and debris.

It is another object of the present invention to provide a dust free mowing system that effectively removes moisture from the ventilation lines.

It is another object of the present invention to provide a dust-free mowing system that keeps bugs and insects from the head of the operator of the mower.

It is another object of the present invention provide a dust-free mowing system that avoids stings by bees, wasps and hornets to the face of the operator of the mower.

It is another object of the present invention to provide a dust-free mowing system that reduces exposure to allergens.

It is another object of the present invention to provide a dust-free mowing system that enhances the ability to work outside for a longer period of time.

It is another object of the present invention to provide a dust free mowing system that reduces fatigue to the operator of the mower.

It is still another object of the present invention to provide a dust free mowing system that is relatively inexpensive and easy-to-use.

It is still a further object of the present invention to provide a dust-free mowing system that can be easily adapted to existing mowers.

These and other objects and advantages of the present invention will become apparent from a reading of the attached specification and appended claims.

### BRIEF SUMMARY OF THE INVENTION

The present invention is a mowing system that reduces exposure to dust and debris. The mowing system comprises a mower, a container having an interior volume that is mounted to the mower, a blower affixed to the container, a hose position within the interior volume of the container, a water separator connected or interconnected to the hose and extending outwardly from the container, a conduit connected or interconnected to the hose and extending outwardly of the container, and a hood connected or interconnected to the conduit. The blower is connected to the hose so as to pass an air flow through the hose. The water separator is adapted to remove liquids from an interior of the hose. The hood is adapted to fit over a human head.

The hose has one end affixed one wall of the container and another end affixed to an opposite wall of the container. The one end of the hose is at a level that is lower than a level of the another end of the hose. The hose coils within the interior of the container. The hose has a first portion extending from the one end and a second portion extending from the opposite end. The hose has a middle portion between the first portion and the second portion. The middle portion is adjacent to a bottom of the interior volume of the container. The first portion is cooperative with the blower. The second portion communicates with the conduit. The water separator is positioned on the middle portion of the hose. The second portion of the hose extends upwardly from this middle portion.

The water separator comprises a drip line affixed to the hose and extending through a bottom wall of the container. The drip line has a tubing connected at an end of the drip line in a location outwardly of the container. This tubing is adapted to allow the liquid to be discharged away from the container. Alternatively, the drip line can have a valve thereon. This valve is movable between an open position and a closed position so as to control a flow of the liquid from the hose. In particular, the water separator comprises a rigid pipe connected between the first portion and the second portion of the hose within the container. This rigid pipe is positioned adjacent a bottom of the interior volume of the container. The rigid pipe has a drip line communicating with an interior thereof and extending through a bottom wall of the container so as to allow liquid from an interior of the rigid pipe to pass outwardly of the container.

The hood comprises a cowl having a screen affixed to a forward portion thereof. The screen is transparent. The hood has a skirt extending downwardly from the cowl. The skirt is adapted to overlie the shoulders of the user and to extend over a portion of the torso of the user. The skirt has a plurality of air holes formed therethrough. The plurality of air holes are adapted to allow the air to be discharged from the hood.

The mower has a surface thereon. The container is placed upon the surface. A fastener is connected to the vehicle and to the container so as to fix a position of the container on the surface of the vehicle. The vehicle can either be a riding lawnmower, a gas-powered lawnmower, an electric lawnmower, or a push mower. The blower has electrical connection lines extending therefrom. The mower has a battery thereon. The electrical connection lines are connected to the battery so that the battery, which powers the mower, can also be used so as to power the ventilation system.

This foregoing Section is intended to describe, with particularity, the preferred embodiment of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view showing the mowing system of the present invention.

FIG. 2 is a plan view showing the interior of the container of the mowing system of the present invention.

FIG. 3 is a cutaway view showing the orientation of the water separator of the mowing system of the present invention.

FIG. 4 is a cross-sectional view showing the water separator of the present invention.

FIG. 5 is a side elevational view showing the water separator in accordance with an alternative embodiment of the present invention.

FIG. 6 is perspective view showing the hood as used with the mowing system of the present invention.

FIG. 7 shows the application of the hood of the present invention upon a human head.

### DETAILED DESCRIPTION OF THE INVENTION

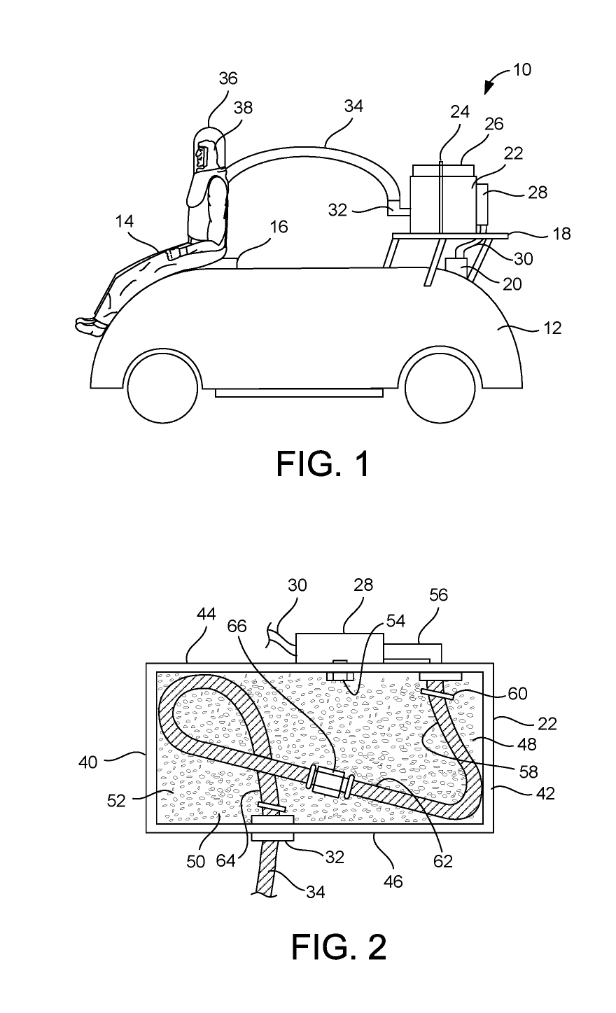

Referring to FIG. 1, there is shown the dust free mowing system 10 in accordance with the preferred embodiment of the present invention. Mowing system 10 is illustrated as being deployed upon a mower 12. The mower 12 is illustrated very generally. The mower 12 can be in the nature of a riding lawnmower, a gas-powered lawnmower, an electric lawnmower, and possibly a push mower. Within the concept of the present invention, it would be possible to use on a golf cart, an all-terrain vehicle, a backhoe, a bulldozer, a forklift, other heavy equipment or recreational vehicles. A person 14 is illustrated as positioned upon a seat 16 on the mower 12. The mower 12 also has a surface 18 and a battery 20 thereon.

The dust-free mowing system 10 of the present invention has a container 22 positioned on the surface 18. In particular, it can be seen that there is a fastener 24 that actually secures the container 22 upon the surface 18. The fastener 24 can be in the nature of a strap, a rope, a bungee cord, or other similar devices. The container 22 is in the nature of an ice chest that has a lid 26 hingedly connected thereto.

A blower 28 is mounted to the side of the container 22. Blower 28 has a pair of electrical connection lines 30 extending therefrom. These electrical connection lines 30 can be connected the battery 20 such that the battery 20 supplies power to the blower 28. The electrical connection lines 30 can include alligator clips at the ends thereof opposite the blower 28 so as to allow for easy securing and removal of the electrical connections with the battery 20.

In FIG. 1, there is an elbow coupling 32 that extends outwardly of the container 22 opposite the blower 28. A conduit 34 is connected to the elbow coupling 32 and extends outwardly away from the container 22. The conduit 34 is connected to a hood 36 that has been placed upon the head 38 of person 14.

In the operation of the dust-free mowing system 10 of the present invention, the container 22 can be placed upon the surface 18. The electrical connection lines 30 can be extended and engage with the battery 20. An on/off switch associated with the blower 28 can be activated such that the blower 28 sends a flow of air through the interior of the container 22. A hose located within the interior of the container 22 (as will be described hereinafter) will reside in heat-exchange relationship with ice, or other cooling liquid, within the interior of the container 22. As such, a cooling flow of air will pass through the elbow coupling 32 into the hose 34 and ultimately enter the hood 36 so as to cool the head 38 of the person 14. Experiments with the present invention have shown that this ventilation system can allow cooling comfort to the head of the user for five to eight hours. The temperature of the cooling air within the hood 36 will be approximately 74° F.

As will be described hereinafter, the hood 36 will extend over the human head 38. As such, the hood 36 will retain the air in proximity to the head 38. Hood 36 can include air holes therein so as to allow for the escape of the air after it is passed by the head 38 of the user. The hood 36 is also very effective in protecting the head 38 of the user 14 from exposure to dirt, pollen, dust and other contaminants. As such, the person 14 can carry out lawn mowing in an extremely comfortable manner.

FIG. 2 illustrates a view of the interior of the container 22. Container 22 has end walls 40 and 42 and sidewalls 44 and 46. The container 22 also includes a bottom wall 48. The walls 40, 42, 44, 46 and 48 define the interior volume 50 of the container 22. A supply of ice 52 is contained within the interior volume 50 of the container 22.

In FIG. 2, it can be seen that the blower 28 is affixed by a fastener 54 to the sidewall 44 of the container 22. The blower 28 includes the electrical connections 30 extending outwardly therefrom. A coupling port 56 will extend from the blower 28 and open through the sidewall 44 so as to be engaged with a hose 58 in the interior volume 50 of the container 22.

The conduit 34 is connected to the coupling 32 that extends through the sidewall 46 of the container 22. As such, the conduit 34 will be connected in fluid communication with the hose 58. The hose 58 has a first portion 60, a middle portion 62 and a second portion 64. It can be seen that the second portion 64 is at a level higher than the first portion 60. The hose 58 will coil in the area between the second portion 64 and the middle portion 62. The middle portion 62 will reside in close proximity to the bottom wall 48 of the container 22 so as to maximize the heat exchange relationship with the ice 52 in the interior volume 50. The water separator 66, as will be described hereinafter, serves to remove liquids from the interior of the hose 58.

During the course of passing ambient air through the ice-filled container 22, condensation will occur. Ultimately, this condensation will cause water to accumulate at the bottommost region of the hose 58 within the interior volume 50 of the container 22. Ultimately, after a sufficient amount of water has been accumulated, then the water can serve to block the optimal flow of air from the blower 28 to the hood 36 or otherwise cause water to flow into the hood 36. As such, a need developed so as to be able to assure that water accumulation would not occur in the bottommost area of the hose 58 within the container 22. So as to assure that the water within the hose 58 will flow in a direction toward the water separator 66, the first portion 60 of the hose 58 is at a level slightly higher than that of the water separator 66. Similarly, the second portion 68 of the hose 58 is also at a level substantially higher than the level of the water separator 66. The downward coiling of the second portion 64 of the hose 58 toward the middle portion 62 further assures that water accumulation within the conduit 38 and within the second portion 64 of the hose 58 will flow toward the water separator 66.

It should be noted that it would be possible to wrap the hose 58 in a wide variety of configurations within the interior 50 of the container 22. However, if the hose 58 has an extended length wrapped around the interior volume 50 of the container 22, then the air that is delivered may become too cold for the user's desires. Additionally, an extended length of wrapping of the hose 58 within the interior volume 50 of the container 22 could potentially interfere with air flow. Additionally, any extended length of tubing within the interior volume 50 could also create pockets of undesired liquid accumulation. As such, Applicant has found that the configuration of the hose 58 within the interior 50 of the container 22 is the best mode for delivering cooled air to the user.

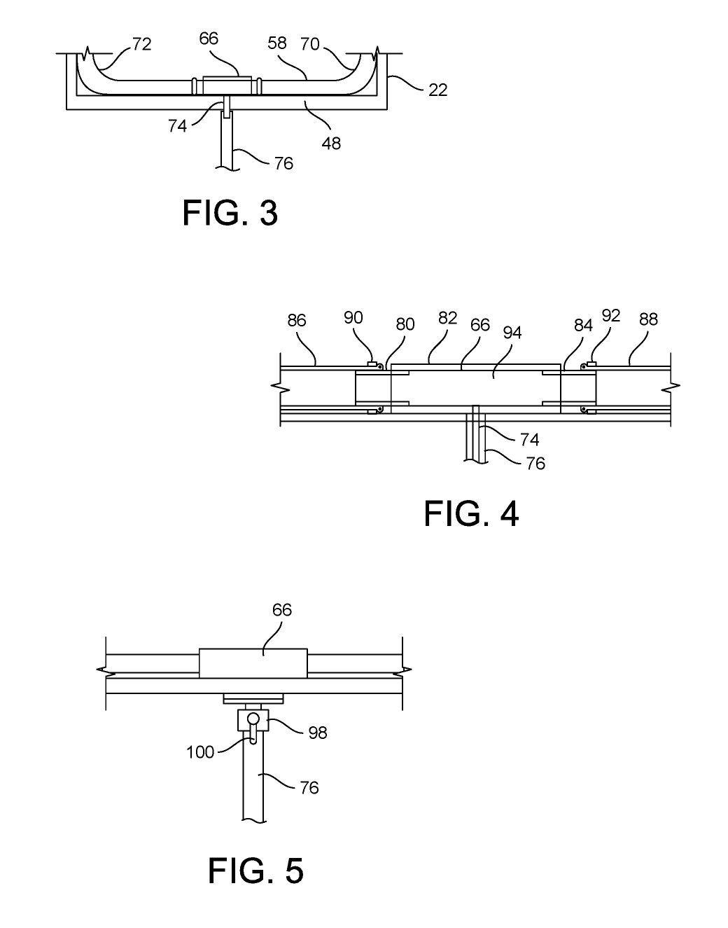

FIG. 3 illustrates the configuration of the water separator 66. The water separator 66 is located adjacent to the bottom wall 48 of the container 22. The hose 58 is connected to opposite ends of the water separator 66. As can be seen, the hose 58 is upturned at one end 70 so as to eventually progress toward the air blower 28. The opposite end 72 also extends upwardly so as to ultimately extend toward the conduit 34. As such, any water within the hose 58 will be gravity-fed downwardly toward the water separator 66. The water separator 66 is illustrated as having a drip line 74 extending through the bottom wall 48 of the container 22. The drip line 74 can communicate with the interior of the water separator 66 so that water can be funneled into the drip line such that any water is ultimately funneled into the drip line 74. A tube 76 is secured to an end of the drip line 74 so that water passing from the hose 58 through the drip line 74 can be delivered to a location exterior of the container 22 and a location which will not damage or corrode the mower 12. The drip line 74 can be a small tube having a diameter of ⅛ to ¼ inch. As such, this will allow water to be released but will not substantially reduce the amount of air flow passing through the interior of the hose 58. The force of the air flow created by the blower 28 will further provides air pressure to discharge any liquids within the water separator 66 through the drip line 74.

FIG. 4 shows a cross-sectional view of the water separator 66. It can be seen that the water separator 66 is in the nature of a pipe formed of a PVC material. A first connector 80 is affixed within one end of the pipe 82 of water separator 66. Another connector 84 is affixed within the opposite end of the pipe 82. Connectors 80 and 84 can be affixed by threading or by the use of adhesive material. It is intended that the connectors 80 and 82 provide a surface upon which a first hose portion 86 can be secured and which a second hose portion 88 can be secured. A clamp 90 extends around the hose portion 86 so as to fix the hose portion 86 to the connector 80. Similarly, another clamp 92 extends around the hose portion 88 so as to secure the end of the hose portion 88 to the connector 84.

Ultimately, any liquids within the hose 58 will pass into the interior 94 of the water separator 66 and will be discharge through the small opening in the interior 94 provided at the drip line 74. It can be seen that the tubing 76 can be fitted around the drip line 74 so as to direct the flow of water as desired.

FIG. 5 shows an alternative embodiment of the water separator 66 of the dust-free mowing system of the present invention. The water separator 66 has a similar configuration to that shown in FIG. 4. However, in FIG. 5, there is a valve 98 that is affixed over the outlet of the water separator 66. The valve 98 includes an arm 100 that can be moved between an open position and a closed position. In the open position, as illustrated in FIG. 5, water will flow freely into the tubing 76. When the arm 100 is in the closed position, water will be blocked from flowing into the tubing 76.

The valve 98 is particularly configured to adapt to those situations where the user desires to have a certain amount of misting or water flowing into the hood 36. Under certain circumstances, a user may find that the flow of mist or liquid enhances the cooling effect. Under the circumstances, the user can close the valve 98 so that water can pass through the hose 58, through the conduit 34, and into the hood 36. In other circumstances, a user may not wish to discharge the entire amount of liquid that is condensed within the hose 58. As such, the arm 100 can be moved to an intermediate position.

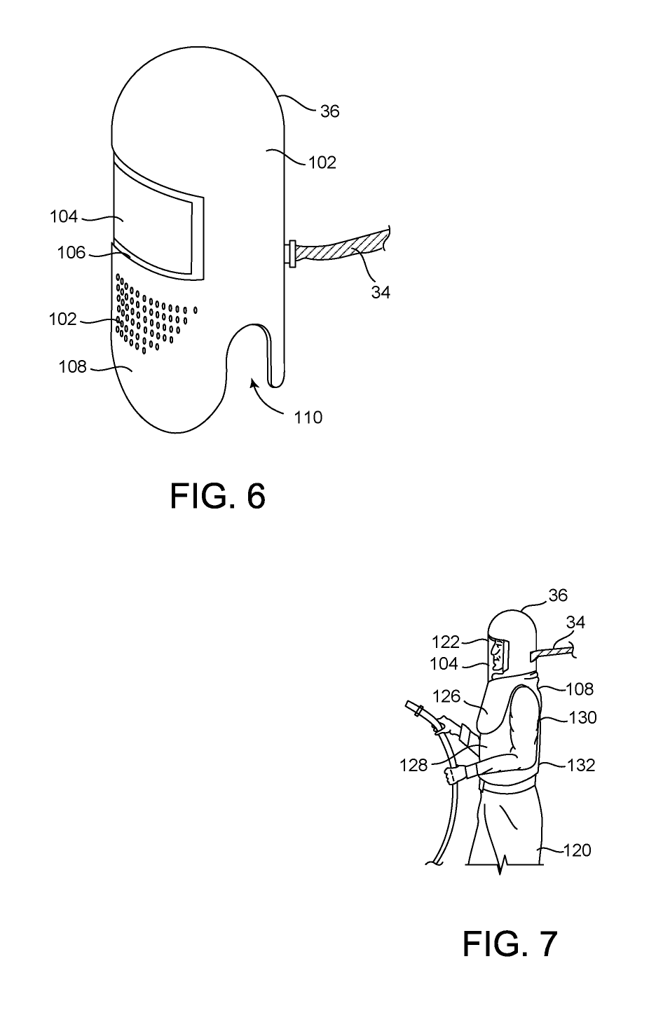

FIG. 6 shows the hood 36 of the present invention. It can be seen that the conduit 34 is connected so as to be in fluid communication with the interior of the hood 36. The hood 36 includes a cowl 102 having a screen 104 affixed to a surface thereof. A frame 106 extends around the screen 104 such that the screen 104 is effectively secured to cowl 102. The screen 104 should be formed of a transparent material. The user will place the cowl 102 over the user's head such that the screen 104 is placed directly in front of the user's eyes. A skirt 108 extends downwardly from the cowl 102 and below the screen 104. The skirt 108 includes a slot 110 that serves to fit over the shoulders of the user. The skirt 108 includes a plurality of air holes 102 so as to allow air to escape from the interior of the hood 36. This will allow for a stream of air to flow around the head of the user and ultimately exit through the air holes 102 or between those spaces between the skirt 100 and the torso and/or shoulders of the user.

FIG. 7 illustrates the hood 36 as applied to the user 120 during the course of gardening activities. In particular, the conduit 34 extends to the hood 36. The user's face 122 is directed toward the screen 104. The skirt 108 has a portion 126 that extends over a portion of the torso 128 of the user 120. The skirt 108 also has another portion 130 that extends over a portion of the back 132 of the user 120.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A mowing system that reduces exposure to dust and debris, the mowing system comprising:
a mower;
a container having an interior volume, said container being mounted to said mower;
a blower affixed to said container;
a hose positioned within said interior volume of said container, said blower connected or interconnected to said hose so as to pass an air flow through said hose;
a water separator connected or interconnected to said hose and extending outwardly from said container, said water separator adapted to remove liquids from an interior of said hose;
a conduit connected or interconnected to said hose and extending outwardly of said container; and
a hood connected or interconnected to said conduit, said hood adapted to fit over the human head.

2. The mowing system of claim 1, said hose having one end affixed to one wall of said container and another end affixed to an opposite wall of said container.

3. The mowing system of claim 2, said one end of said hose being at a level higher than a level of said another end of said hose, said hose coiling within said interior of said container.

4. The mowing system of claim 3, said hose having a first portion extending from said one end and having a second portion extending from said another end, said hose having a middle portion between said first portion and said second portion, said middle portion extending adjacent to a bottom of said interior volume of said container.

5. The mowing system of claim 4, said first portion cooperative with said blower, said second portion communicating with said conduit.

6. The cooling system of claim 4, said water separator position on said middle portion of said hose, said second portion of said hose extending upwardly from said middle portion.

7. The morning system of claim 1, said water separator comprising a drip line affixed to said hose and extending through a bottom wall of said container.

8. The mowing system of claim 7, said drip line having a tubing connected at an end of said drip line outwardly of said container, said tubing adapted to allow the liquids to be discharged away from said container.

9. The mowing system of claim 7, said drip line having a valve thereon, said valve movable between an open position and a closed position so as to control a flow of the liquid from the hose.

10. The mowing system of claim 1, said water separator comprising a rigid pipe connected between a first portion and a second portion of said hose within said container, said rigid pipe positioned adjacent a bottom of said interior volume of said container, said rigid pipe having a drip line communicating with an interior thereof and extending through a bottom wall of said container so as to allow liquids from an interior of said rigid pipe to pass outwardly of said container.

11. The mowing system of claim 1, said hood comprising a cowl having a screen affixed to a forward portion of said cowl, said screen being transparent.

12. The mowing system of claim 11, said hood having a skirt extending downwardly from said cowl, said skirt adapted to overlie shoulders of the user and will extend over a portion of a torso of the user.

13. The mowing system of claim 12, said skirt having a plurality of air holes formed therethrough, said plurality of air holes adapted to allow air to be discharged from said hood.

14. The mowing system of claim 1, said mower having a surface thereon, said container positioned upon said surface.

15. The mowing system of claim 14, further comprising:
a fastener connected to said mower and to said container so as to fix a position of said container on said surface of said mower.

16. The mowing system of claim 14, said mower selected from the group consisting of a riding lawnmower, a gas lawnmower, an electric lawnmower, and a push lawnmower.

17. The mowing system of claim 1, said blower having an electrical connection line extending therefrom, said mower having a battery thereon, said electrical connection line connected to said battery.

18. A dust free system for use on a human head, the dust-free system comprising:
a vehicle having a surface thereon;
a container having an interior volume, said container positioned upon said surface;
a blower affixed to said container;
a hose positioned within said interior volume of said container, said blower connected or interconnected to said hose so as to pass an air flow through said hose;
a water separator connected or interconnected to said hose and extending outwardly of said container, said water separator adapted to remove liquids from an interior of said hose;
a conduit connected or interconnected to said hose and extending outwardly of said container; and
a hood connected or interconnected to said conduit, said hood adapted to fit over the human head.

19. The dust free system of claim 18, said water separator comprising a drip line in communication with an interior of said hose and extending downwardly therefrom so as to extend outwardly through a bottom wall of said container.

20. The dust-free system of claim 18, said vehicle being a mower.
